(19) United States
(12) Patent Application Publication
(10) Pub. No.: US 2015/0170178 A1
(43) Pub. Date: Jun. 18, 2015

(54) METHOD AND SYSTEM FOR RECEIVING CUSTOMER FEEDBACK FOR PRESENTED OFFERS

(71) Applicant: MasterCard International Incorporated, Purchase, NY (US)

(72) Inventor: Rohit CHAUHAN, Somers, NY (US)

(73) Assignee: MasterCard International Incorporated, Purchase, NY (US)

(21) Appl. No.: 14/104,341

(22) Filed: Dec. 12, 2013

(51) Int. Cl. G06Q 30/02; G06Q 30/06

(52) U.S. Cl. CPC G06Q 30/0211; G06Q 30/0203; G06Q 30/0224; G06Q 30/0631; G06Q 30/0245; G06Q 30/0269; G06Q 30/0255

(57) ABSTRACT

A method for distributing feedback-based offers includes: storing offer data entries, each entry including an offer identifier, offer data, and distribution conditions; storing a consumer profile, the profile including data related to a consumer including a device identifier, consumer data, and offer feedback data; identifying at least one offer data entry based on the distribution conditions and the consumer data and offer feedback data of the consumer profile; transmitting the offer data included in each identified offer data entry to a computing device associated with the device identifier; receiving, from the computing device, an interest level selection corresponding to each identified offer data entry, the interest level selection representing one of a plurality of interest levels indicated by the consumer as a measure of interest towards the respective offer; and updating the offer feedback data to include the offer data and interest level selection for each identified offer data entry.

### FIELD

The present disclosure relates to the receiving of consumer feedback for presented offers, specifically using multiple interest levels to gauge consumer feedback of offers and use thereby in identifying future offers for distribution.

### BACKGROUND

Merchants, offer providers, manufacturers, retailers, and other entities often distribute offers (e.g., deals, coupons, discounts, advertisements, etc.) to consumers in an effort to entice the consumer to make a purchase. In many instances, merchants may hope that an offer will bring a consumer to their store, and that the consumer will purchase additional items beyond what is identified in the offer. As a result, offer providers often have a desire to distribute offers to those consumers that are most likely to redeem the offer.

Methods and systems have been developed to identify ideal consumers for offer distribution, or to identify ideal offers for distribution to a consumer. Many of these systems may rely on detailed information associated with a consumer, such as demographic information or spending behaviors. However, while such data may be specific to a consumer or group of consumers, consumers within a group may greatly vary in offer redemption behavior, thus making such methods less than optimal.

In some systems, consumers may be polled when registering to receive offers to determine what offers the consumer would prefer to receive. However, many consumers may not have adequate foresight to predict offers they prefer. In addition, as circumstances of the consumer may change, the consumer themselves may be required to update their information in order to accommodate for their changed circumstances. Such actions being required of a consumer may discourage consumers from using such a system.

In other systems, consumers may be able to identify if they like an offer and want to see more similar offers, or if they dislike an offer and do not want to see the offer or similar offers again. Such a system may be able to adapt to consumers on a limited basis. However, such restrictive feedback may make it difficult for offer providers to adequately pare down a consumer's interest. Furthermore, a consumer may like one aspect of an offer, such as the merchant, the offered product, the type of discount, etc., while not liking another aspect. For example, the consumer may like an offered product, but not prefer the merchant with whom it may be redeemed. Current systems for providing feedback fail to provide consumers with multiple levels of interest with regards to an offer, and therefore may not provide strong and accurate offer distribution.

Thus, the present inventor believes there is a need for a technical solution to distribute offers based on multiple interest levels of consumer feedback.

### SUMMARY

The present disclosure provides a description of systems and methods for distributing feedback-based offers and providing consumer feedback to offers.

A method for distributing feedback-based offers includes: storing, in an offer database, a plurality of offer data entries, wherein each offer data entry includes data related to an offer for the purchase of goods or services including at least an offer identifier, offer data, and one or more distribution conditions; storing, in a consumer database, a consumer profile, wherein the consumer profile includes data related to a consumer including at least a device identifier, consumer data, and offer feedback data; identifying, in the offer database, at least one offer data entry based on the included one or more distribution conditions and the consumer data and offer feedback data included in the consumer profile; transmitting, by a transmitting device, at least the offer data included in each of the identified at least one offer data entry to a computing device associated with the device identifier included in the consumer profile; receiving, from the computing device, an interest level selection corresponding to each of the identified at least one offer data entry, wherein the interest level selection represents one interest level of a plurality of interest levels indicated by the consumer as a measure of interest towards the respective related offer; and updating, in the consumer profile, the offer feedback data to include at least the offer data and received interest level selection for each of the identified at least one offer data entry.

A method for providing consumer feedback to offers includes: storing, in a memory, a device identifier associated with a computing device associated with a consumer; receiving, by a receiving device, offer data related to an offer for the purchase of goods or services, wherein the offer data is identified based on at least consumer data and offer feedback data associated with the consumer; displaying, by a display device, the received offer data and a listing of interest levels, wherein the listing of interest levels includes a plurality of interest levels associated with interest towards the offer related to the received offer data; receiving, by an input device, an interest level selection, wherein the interest level selection indicates one interest level of the plurality of interest levels; transmitting, by a transmitting device, at least the stored device identifier and the received interest level selection for use in updating the offer feedback data associated with the consumer.

A system for distributing feedback-based offers includes an offer database, a consumer database, a processing device, a transmitting device, and a receiving device. The offer database is configured to store a plurality of offer data entries, wherein each offer data entry includes data related to an offer for the purchase of goods or services including at least an offer identifier, offer data, and one or more distribution conditions. The consumer database is configured to store, a consumer profile, wherein the consumer profile includes data related to a consumer including at least a device identifier, consumer data, and offer feedback data. The processing device is configured to identify, in the offer database, at least one offer data entry based on the included one or more distribution conditions and the consumer data and offer feedback data included in the consumer profile. The transmitting device is configured to transmit at least the offer data included in each of the identified at least one offer data entry to a computing device associated with the device identifier included in the consumer profile. The receiving device is configured to receive, from the computing device, an interest level selection corresponding to each of the identified at least one offer data entry, wherein the interest level selection represents one interest level of a plurality of interest levels indicated by the consumer as a measure of interest towards the respective related offer. The processing device is further configured to update, in the consumer profile, the offer feedback data to include at least the offer data and received interest level selection for each of the identified at least one offer data entry.

A system for providing consumer feedback to offers includes a memory, a receiving device, a display device, an input device, and a transmitting device. The memory is configured to store a device identifier associated with a computing device associated with a consumer. The receiving device is configured to receive offer data related to an offer for the purchase of goods or services, wherein the offer data is identified based on at least consumer data and offer feedback data associated with the consumer. The display device is configured to display the received offer data and a listing of interest levels, wherein the listing of interest levels includes a plurality of interest levels associated with interest towards the offer related to the received offer data. The input device is configured to receive an interest level selection, wherein the interest level selection indicates one interest level of the plurality of interest levels. The transmitting device is configured to transmit at least the stored device identifier and the received interest level selection for use in updating the offer feedback data associated with the consumer.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for receiving consumer feedback and providing feedback-based offers to consumers in accordance with exemplary embodiments.

FIG. 2 is a block diagram illustrating the processing server of FIG. 1 for the distribution of feedback-based offers in accordance with exemplary embodiments.

FIG. 3 is a block diagram illustrating the computing device of FIG. 1 for the providing of consumer feedback for offers in accordance with exemplary embodiments.

FIG. 4 is a flow diagram illustrating a process for distributing targeted offers and receiving consumer feedback for targeted offers using the system of FIG. 1 in accordance with exemplary embodiments.

FIG. 5 is a diagram illustrating a graphical user interface of the computing device of FIG. 3 for the providing of consumer feedback for an offer in accordance with exemplary embodiments.

FIG. 6 is a flow chart illustrating an exemplary method for distributing feedback-based offers in accordance with exemplary embodiments.

FIG. 7 is a flow chart illustrating an exemplary method for providing consumer feedback to offers in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc.

### System for Distributing Feedback-Based Offers and Providing Consumer Feedback

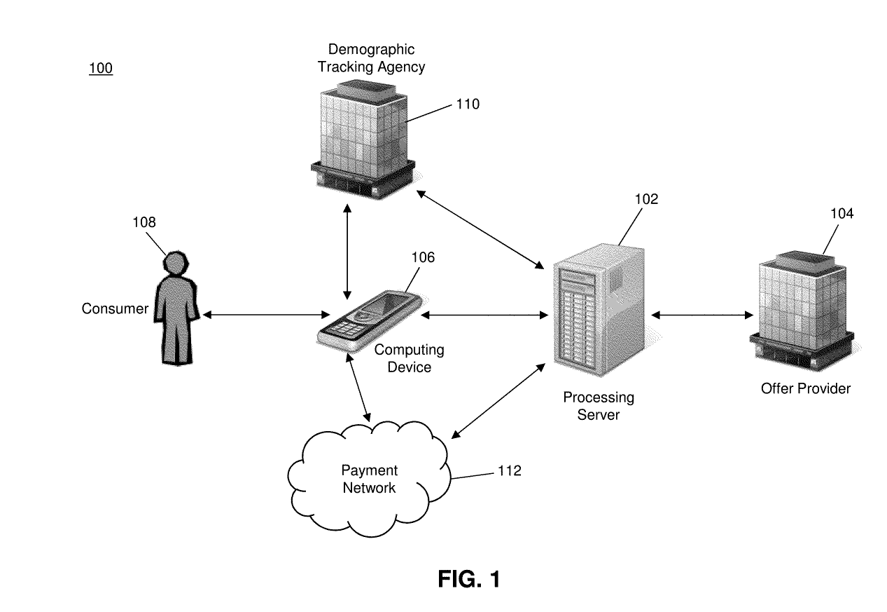

FIG. 1 illustrates a system 100 for the providing of feedback-based offers to consumers and for the providing of consumer feedback to the offers for use in future offer distribution.

The system 100 may include a processing server 102. The processing server 102, discussed in more detail below, may be configured to distribute offers to consumers based on consumer feedback to previously distributed offers. The processing server 102 may receive data related to offers for distribution from an offer provider 104. It will be apparent to persons having skill in the relevant art that the offer provider 104 may be an offer aggregator, merchant, manufacturer, retailer, advertiser, advertising agency, political entity, charity or other suitable entity that provides advertisements of any kind for distribution. The received data may include offer data and distribution conditions for each offer.

The processing server 102 may store the received data in an offer database, discussed in more detail below. The processing server 102 may also store consumer profiles in a consumer database, also discussed in more detail below. Each consumer profile may include feedback data regarding consumer feedback to previously distributed offers, and a device identifier. This feedback data may or may not include conventional feedback as described above in the background section, but additionally or exclusively includes the interest level consumer feedback gathered as explained below. The device identifier may be an identification value associated with a computing device 106. The computing device 106 may be associated with a consumer 108 that is related to the respective consumer profile. The computing device 106 may be any type of computing device suitable for performing the functions as disclosed herein, such as a desktop computer, laptop computer, notebook computer, tablet computer, cellular phone, smart phone, etc.

The processing server 102 may, as discussed in more detail below, identify an offer receiving from the offer provider 104 for distribution to the computing device 106 associated with the consumer 108, based on the feedback data from the consumer 108 and the distribution conditions for the offer, e.g., when, where and how the offer is to be distributed, under what conditions and to whom based on customer profiles, etc. as examples. The processing server 102 may then distribute the identified offer to the computing device 106 using methods that will be apparent to persons having skill in the relevant art, such as e-mail, short message service (SMS) message, multimedia message service (MMS) message, via a website or application program, etc. For example, an offer might be distributed to the computing device 106 when a transaction by the consumer 108 is initiated or completed at a point of sale (not illustrated), perhaps using the computing device 106, through the payment network 112 that reports at least some aspect of the transaction (e.g., merchant type, card present or remote transaction, etc.) to the processing server 102.

The computing device 106 may receive the offer and may display the offer to the consumer 108. The consumer 108 may then select one interest level of a plurality of interest levels regarding their interest in the displayed offer. As discussed in more detail below, the plurality of interest levels may include varying strengths of interest, interest in specific aspects of the offer (e.g., the type of offer, the merchant, the product, the value, etc.), or other metrics of the consumer's interest in the offer. The computing device 106 may receive the consumer's selection, and may transmit the feedback back to the processing server 102.

The processing server 102 may then update the feedback data consumer profile of the consumer 108 based on the feedback. The processing server 102 may utilize the updated feedback data in the identification of future offers for distribution to the consumer 108. By continuously receiving feedback from consumers, the processing server 102 may adapt to changing consumer behaviors and may identify the most relevant offers for distribution to the consumer 108 at any given time. In addition, the use of multiple interest levels may enable the processing server 102 to identify offers that are more uniquely suited to the individual consumer 108 than may be possible using existing systems and methods.

In some embodiments, the processing server 102 may also receive additional data associated with each consumer 108 for use in the identification of offers. For example, the system 100 may include a demographic tracking agency 110. The demographic tracking agency 110 may collect demographic information (e.g., age, gender, income, residential status, familial status, marital status, education, occupation, zip code, postal code, etc.) on the consumer 108, and may provide the collected demographic information to the processing server 102. The processing server 102 may include the demographic information in the consumer profile for the consumer 108 and use the information in addition to the feedback data when identifying an offer for distribution to the consumer 108. In some embodiments, the demographic information may be rendered anonymous or otherwise made not personally identifiable to the consumer 108 using systems and methods that will be apparent to persons having skill in the relevant art. In other embodiments, the processing server 102 may receive explicit consent from the consumer 108 for the obtaining and use of the consumer's demographic information.

In some embodiments, the processing server 102 may also utilize consumer purchase or spending behavior in the identification of offers. In such an embodiment, the system 100 may include input from a payment network 112. The payment network 112 may store transaction data for payment transactions involving the consumer 108, and may transmit the data to the processing server 102. The processing server 102 may then utilize the data, in addition to the feedback data, when identifying offers for distribution to the consumer 108. In some embodiments, the processing server 102 may obtain information related to the transaction data from the payment network 112 with consent of the consumer 108 if sufficiently detailed as to create privacy concerns.

### Processing Server

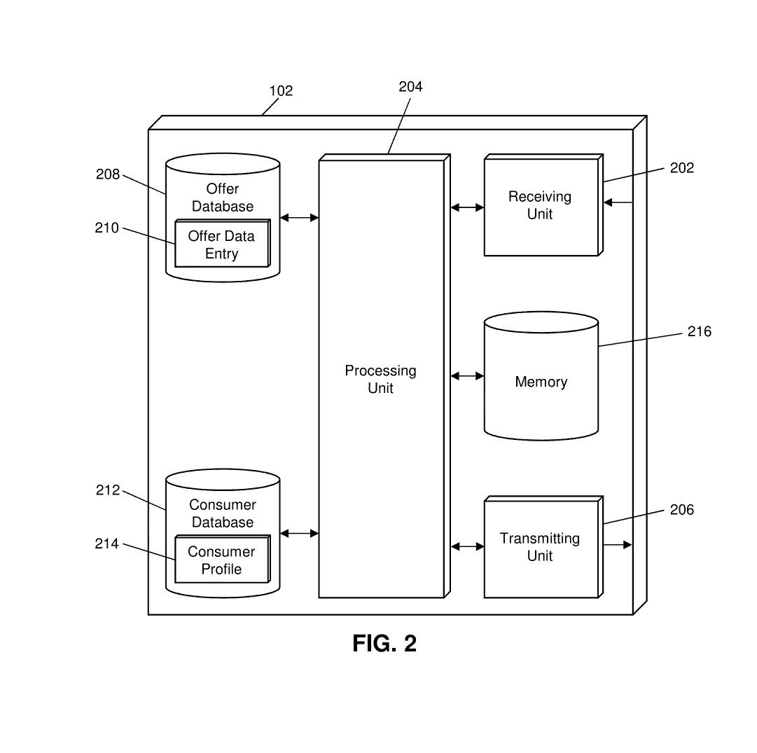

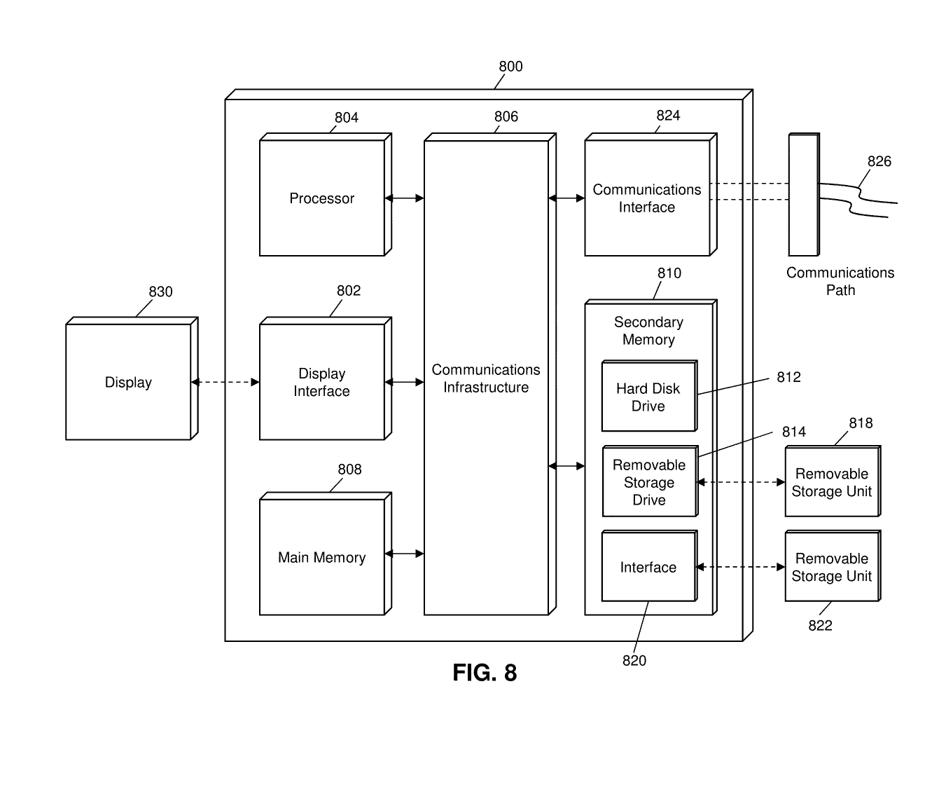

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive data from the offer provider 104 related to offers for the purchase of goods or services to be distributed to consumers 108. The processing server 102 may also include a processing unit 204. The processing unit 204 may be a configurable hardware computer processor or processors working in tandem and may be configured to perform processing functions of the processing server 102 as discussed herein. The processing unit 204 may store the received data in an offer database 208 as one or more offer data entries 210.

Each offer data entry 210 stored in the offer database 208 may include data related to an offer including at least an offer identifier, offer data, and one or more distribution conditions. The offer identifier may be a unique value used to identify the respective offer data entry 210 and/or related offer, such as an identification number, a universal product code, a stock-keeping unit, a registration number, etc. The offer data may include an offer name, offer description, offer category, offer type, offer amount, transaction modifier, merchant data, manufacturer data, product data, start date, expiration date, quantity, limitations on redemption, or any other suitable data as will be apparent to persons having skill in the relevant art.

The one or more distribution conditions may be conditions used by the processing unit 204 for the identification of an offer based on consumer feedback data and any additional data (e.g., demographics information and transaction or spending data). The distribution conditions may include offer data (e.g., offer types, merchant name(s), product name(s), product manufacturer(s), etc.), redemption requirements (e.g., redeemed one or more similar offers), interest level thresholds (e.g., shown great interest in five or more similar offers, etc.), or other suitable conditions as will be apparent to persons having skill in the relevant art.

The receiving unit 202 may be further configured to receive communications from the computing device 106, such as registration for receiving distributed offers. The registration may include a device identifier associated with the computing device 106, such as a media access control address, registration number, serial number, identification number, phone number, e-mail address, or other suitable value as will be apparent to persons having skill in the relevant art. The registration may also include consumer data associated with a consumer 108 associated with the computing device 106. The consumer data may include a consumer name, consumer preferences, offer preferences, preferred method of distribution, and/or other suitable data.

The processing unit 204 may generate a consumer profile 214 associated with the consumer 108 and store the generated consumer profile 214 in a consumer database 212. The consumer profile 214 may include the consumer data and device identifier. The consumer profile 214 may also include any feedback data regarding feedback provided by the consumer 108 to distributed offers. The feedback data may include offer data, interest level data, and any other suitable data for each offer for which feedback was provided by the consumer 108.

The receiving unit 202 may be further configured to receive consumer data from the demographics tracking agency 110 and/or the payment network 112. The processing unit 204 may update the consumer data stored in the consumer profile 214 for the respective consumer with the received consumer data. In some embodiments, the consumer profile 214 may include a consumer identifier associated with the consumer 108. In such an embodiment, the received data may include a consumer identifier, which may be used by the processing unit 204 to identify the consumer profile 214 to which the received data is to be added.

The processing unit 204 may be configured to identify an offer for distribution to the consumer 108 based on the one or more distribution conditions included in each offer data entry 210 and the consumer data and feedback data stored in the consumer profile 214 for the consumer 108. Once an offer has been identified, the offer data included in the offer data entry 210 may be transmitted to the computing device 106 associated with the device identifier included in the consumer profile 214 by a transmitting unit 206. The transmitting unit 206 may be configured to transmit data over one or more networks via one or more network protocols, including the offer data for the identified offer.

The receiving unit 202 may be configured to receive consumer feedback from the computing device 106 regarding the previously distributed offer. The consumer feedback may include at least an interest level selection corresponding to the distributed offer. The interest level selection may represent one interest level of a plurality of interest levels as indicated by the consumer 108 as a measure of interest towards the respective offer. The interest levels may include: no interest, interest with non-ideal timing, interest with lack of personalization, great interest, interest in offer type or category, interest in product, interest in merchant, etc. In some instances, the interest level may be a combination of multiple interest levels. In other instances, the interest level selection may include multiple interest levels (e.g., interest in product, non-interest in merchant). The processing unit 204 may update the feedback data in the consumer profile 214 based on the received interest level selection.

The processing server 102 may also include a memory 216. The memory 216 may store any additional data suitable for performing the functions as disclosed herein. For example, the memory 216 may store program code for execution by the processing unit 204 to perform the functions disclosed herein. The memory 216 may also include algorithms for the identification of offer data entries 210 using the included distribution conditions, and other suitable data as will be apparent to persons having skill in the relevant art.

### Computing Device

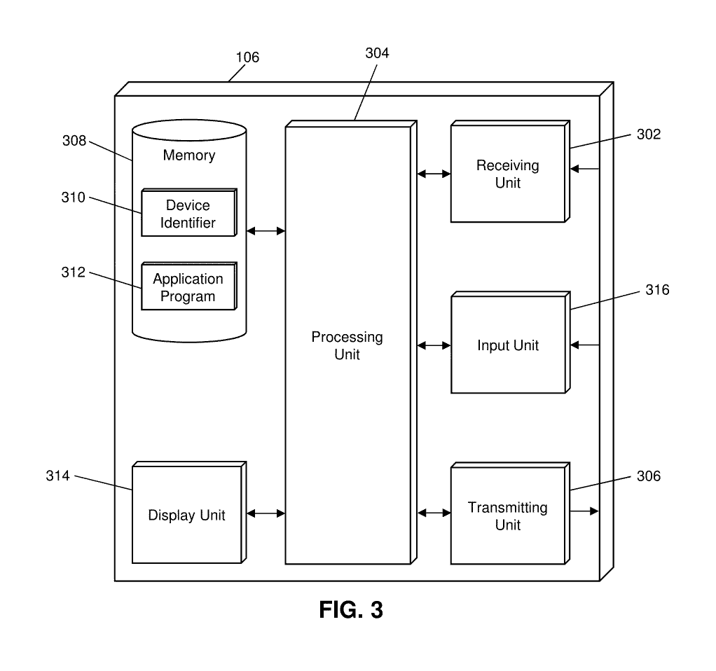

FIG. 3 illustrates an embodiment of the computing device 106 of the system 100. As stated above, the computing device 106 may be any type of computing device suitable for performing the functions as disclosed herein, such as a desktop computer, laptop computer, notebook computer, tablet computer, cellular phone, smart phone, etc. It will be apparent to persons having skill in the relevant art that the embodiment of the computing device 106 illustrated in FIG. 3 is provided as illustration only and may not be exhaustive to all possible configurations of the computing device 106 suitable for performing the functions as discussed herein. For example, the computer system 800 illustrated in FIG. 8 and discussed in more detail below may be a suitable configuration of the computing device 106.

The computing device 106 may include a receiving unit 302. The receiving unit 302 may be configured to receive offer data from the processing server 102 for one or more offers distributed to the consumer 108 based on consumer feedback data. The computing device 106 may also include a processing unit 304. The processing unit 304 may be configured to identify the offer data as received by the receiving unit 302 and communicate the offer data to a display unit 314 for display to the consumer 108. The display unit 314 may be any suitable type of display for performing the functions as disclosed herein, such as a liquid crystal display, light-emitting diode display, capacitive touch display, etc.

The consumer 108 may view the displayed offer and may provide an interest level selection regarding the consumer's interest in the offer via an input unit 316. The input unit 316 may be any type of input suitable for performing the functions disclosed herein as will be apparent to persons having skill in the relevant art, such as a keyboard, mouse, click wheel, microphone, camera, control pad, touch screen, etc. The computing device 106 may further include a transmitting unit 306. The transmitting unit 306 may be configured to transmit data over one or more networks via one or more network protocols, including transmitting feedback data to the processing server 102. The feedback data may include at least the interest level selection and a device identifier 310.

The device identifier 310 may be the identifier associated with the computing device 106 and stored in the respective consumer profile 214 of the processing server 102. The device identifier 310 may be stored in a memory 308 of the computing device 106, and accessed by the processing unit 304 for inclusion in the feedback data transmitted to the processing server 102 by the transmitting unit 306. In some embodiments, the feedback data may further include an offer identifier associated with the offer to which feedback is being provided. The offer identifier may be included in the received offer data and included in the feedback data accordingly.

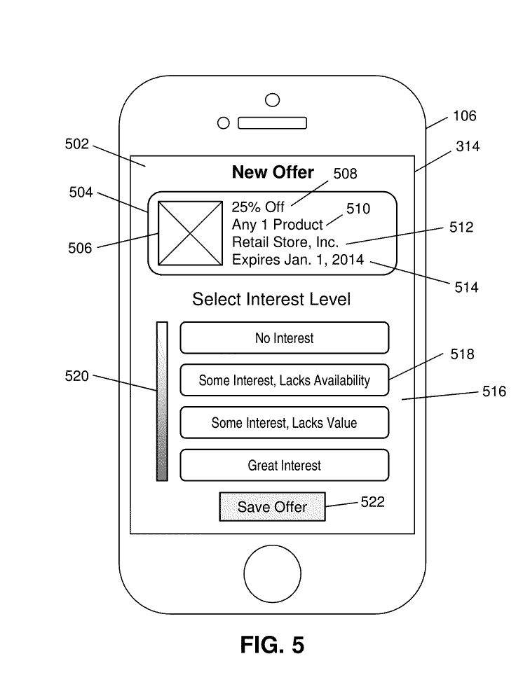

In some embodiments, the memory 308 may further include program code for an application program 312. The program code may be executed by the processing unit 304 for executing the application program 312, thus making the processing unit a specific purpose computer. The application program 312 may be configured to provide for a user interface to be displayed by the display unit 314 to display offer data for a received offer to the consumer 108 and to accept user input of an interest level selection for the respective displayed offer. An example user interface of the application program 312 for the providing of consumer feedback of an offer via an interest level selection is illustrated in FIG. 5 and discussed below.

### Process for Distributing Feedback-Based Offers and Providing Consumer Feedback

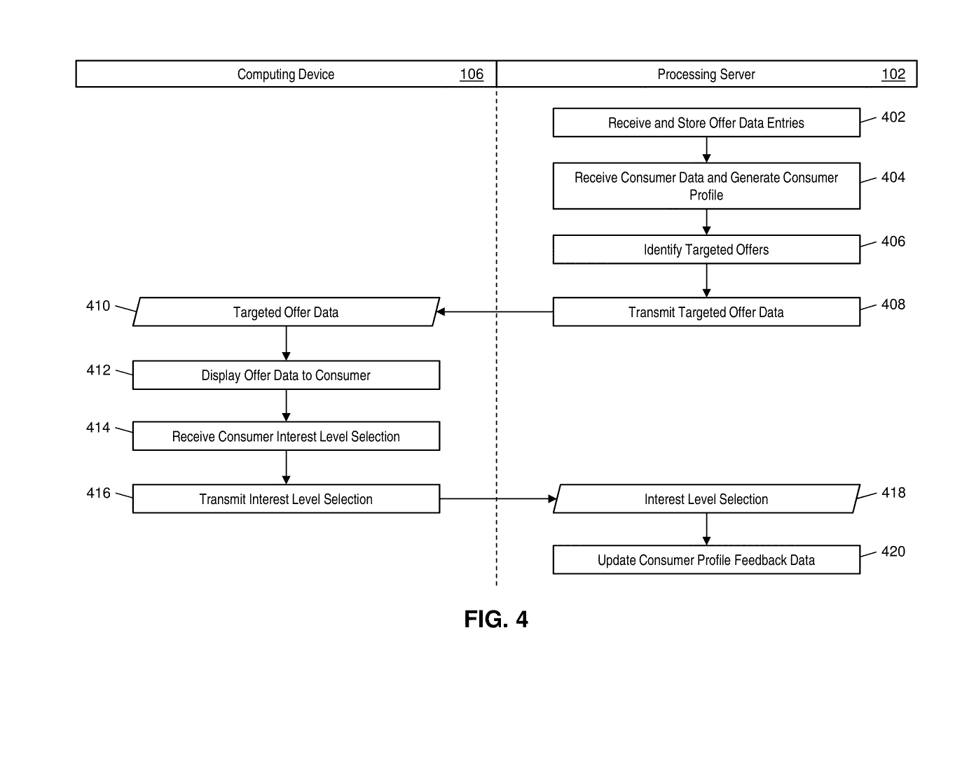

FIG. 4 illustrates a process for the identification and distribution of feedback-based offers to the consumer 108 by the processing server 102 and the providing of consumer feedback to distributed offers by the consumer 108 to the processing server 102.

In step 402, the receiving unit 202 of the processing server 102 may receive data for one or more offers, which may be stored as offer data entries 210 in the offer database 208 by the processing unit 204 of the processing server 102. Each offer data entry 210 may include at least an offer identifier, offer data, and one or more distribution conditions. In step 404, the receiving unit 202 may receive consumer data and a device identifier associated with the computing device 106. The processing unit 204 may generate a consumer profile 214 for the consumer 108 associated with the received consumer data and may store the consumer profile 214 in the consumer database 212.

In step 406, the processing unit 204 of the processing server 102 may identify one or more offer data entries 210 related to offers for distribution to the consumer 108 based on the included one or more distribution conditions and the consumer data included in the associated consumer profile 214. In step 408, the transmitting unit 206 of the processing server 102 may transmit the offer data included in the identified one or more offer data entries 210 to the computing device 106. In step 410, the receiving unit 302 of the computing device 106 may receive the offer data of the one or more offer data entries.

In step 412, the display unit 314 of the computing device 106 may display the received offer data for the one or more offer data entries to the consumer 108. In step 414, the input unit 316 of the computing device 106 may receive the interest level selection of the consumer 108 with respect to each offer related to the displayed offer data. The interest level selection may represent one interest level of a plurality of interest levels indicated by the consumer 108 as a measure of interest towards the respective offer.

In step 416, the transmitting unit 306 of the computing device 106 may transmit the interest level selection for each offer to the processing server 102. In some embodiments, the computing device 106 may also transmit the device identifier 310 associated with the computing device 106 and/or the offer identifier associated with each offer to the processing server 102. In step 418, the receiving unit 202 of the processing server 102 may receive the data from the computing device 106.

In step 420, the processing unit 204 of the processing server 102 may update the feedback data included in the consumer profile 214 associated with the consumer 108 based on the received interest level selection(s). In some embodiments, the processing unit 204 may first identify the consumer profile 214 based on the device identifier 310 prior to updating of the feedback data. In some instances, the processing unit 204 may identify the one or more offer data entries 210 for which feedback is provided based on offer identifiers included in the feedback data received from the computing device 106.

As will be apparent to persons having skill in the relevant art, the process may repeat steps 406-420 to continue to identify offers for distribution to the consumer 108 and the updating of consumer feedback regarding the distributed offers. In such an instance, the offers may be identified based on the continually updated feedback data, which may provide for more accurate, and thereby more effective, offers for distribution to the consumer 108.

### Graphical User Interface

FIG. 5 is an illustration of a graphical user interface of the computing device 106 for the selection of a consumer interest level for a displayed offer consistent with the systems and methods as discussed herein. It is noted that the graphical user interface illustrated in FIG. 5 and discussed herein is provided as a means of illustration only and that additional interfaces and configurations thereof may be suitable for use in performing the functions disclosed herein as will be apparent to persons having skill in the relevant art.

The display unit 314 of the computing device 106 may display a feedback screen 502. The feedback screen 502 may be a screen displayed via the application program 312 stored in the memory 308 of the computing device 106 and executed by the processing unit 304. The feedback screen 502 may include received offer data 504.

The received offer data 504 may include an offer picture 506, an offer amount 508, a limitation on redemption 510, a merchant name 512, and an expiration date 514. In the example illustrated in FIG. 5, the offer may be for 25% off any one product at Retail Store, Inc., and must be redeemed prior to Jan. 1, 2014. It will be apparent to persons having skill in the relevant art that the offer data 504 may not include all of this data, or may include additional data, such as a start date, additional limitations on redemption 510, etc.

The feedback screen 502 may further include an interest level selection 516. The interest level selection 516 may include a plurality of interest levels 518. Each interest level 518 may represent interest towards the offer corresponding to the displayed offer data 504. As illustrated in FIG. 5, the interest levels 518 may indicate that the consumer 108 is not interested in the offer, is interested in the offer but finds the availability (e.g., a single product and/or merchant for redemption) lacking, is interested in the offer but finds the value lacking, or is greatly interested in the offer.

The feedback screen 502 may also include an interest meter 520. The interest meter 520 may be used to graphically illustrate the level of interest that each interest level 518 represents in instances where each interest level 518 represents a different strength of interest. For example, the gradient of the interest meter 520 illustrated in FIG. 5 may indicate to the consumer 108 that the consumer's perceived interest is greater as the consumer 108 goes down in the interest level selection 516. It will be apparent to persons having skill in the relevant art that the interest meter 520 may not be suitable for some interest level selections 516.

As illustrated in FIG. 5, each interest level 518 may be a button, or the interest meter can function as a slide, or both for optional selection by the consumer 108. When the consumer 108 interacts with the button for an interest level 518, the computing device 106 may receive the corresponding interest level selection and provide the respective feedback to the processing server 102. It will be apparent to persons having skill in the relevant art that additional input methods for providing consumer interest level selections may be used. For example, if multiple interest levels 518 may be selected, checkboxes or other similar types of inputs may be used to enable the consumer 108 to select multiple interest levels 518 prior to submitting of the feedback data to the processing server 102.

The feedback screen 502 may further include a save offer button 522. The save offer button 522 may be used by the consumer 108 in order to save the offer related to the offer data 504 for later use by the consumer 108. When the save offer button 522 is pressed or through some other action (e.g., closing the screen), the processing unit 304 of the computing device 106 may store the offer data 504 in the memory 308 of the computing device 106 for later use. Methods and systems for storing offer data in a computing device 106 and use thereof will be apparent to persons having skill in the relevant art.

### Exemplary Method for Distributing Feedback-Based Offers

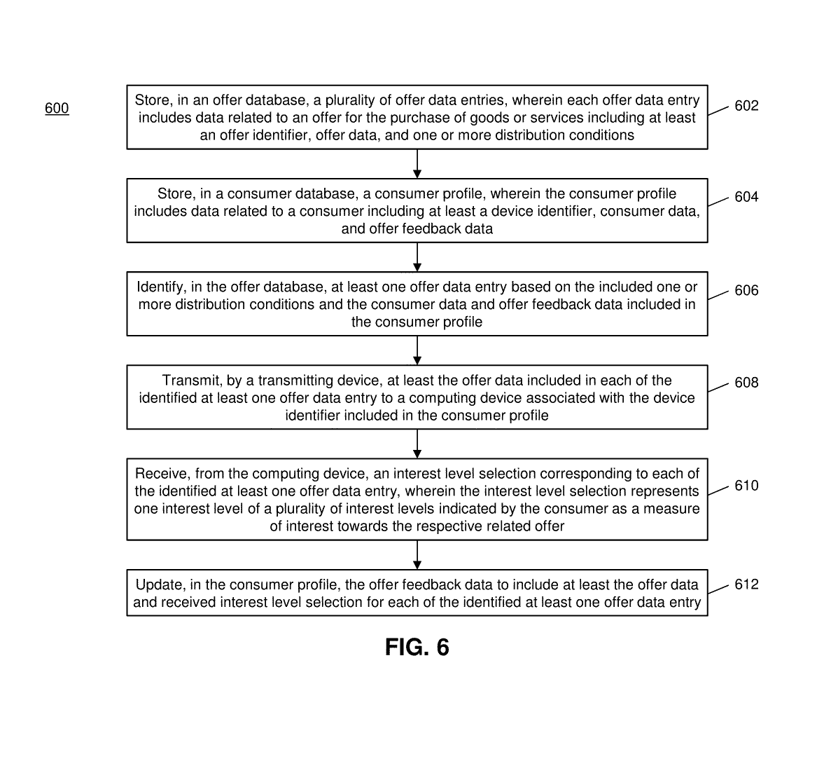

FIG. 6 illustrates a method 600 for the distribution of feedback-based offers to a consumer.

In step 602, a plurality of offer data entries (e.g., offer data entries 210) may be stored in an offer database (e.g., the offer database 208), wherein each offer data entry 210 includes data related to an offer for the purchase of goods or services including at least an offer identifier, offer data, and one or more distribution conditions. In one embodiment, the offer data may include at least one of: offer name, offer description, offer category, offer type, offer amount, transaction modifier, merchant data, manufacturer data, product data, start date, expiration date, quantity, and limitations on redemption.

In step 604, a consumer profile (e.g., the consumer profile 214) may be stored in a consumer database (e.g., the consumer database 212), wherein the consumer profile 214 includes data related to a consumer (e.g., the consumer 108) including at least a device identifier (e.g., the device identifier 310), consumer data, and offer feedback data. In one embodiment, the consumer data may include at least one of: demographic data, transaction data, and offer redemption data. In step 606, at least one offer data entry 210 may be identified, in the offer database 208, based on the included one or more distribution conditions and the consumer data and offer feedback data included in the consumer profile 214.

In step 608, at least the offer data included in each of the identified at least one offer data entry 210 may be transmitted, by a transmitting device (e.g., the transmitting unit 206) to a computing device (e.g., the computing device 106) associated with the device identifier 310 included in the consumer profile 214. In one embodiment, the computing device 106 may be a mobile communication device, and the device identifier 310 may be at least one of: a phone number, an Internet protocol address, a media access control address, a serial number, a registration number, and an e-mail address.

In step 610, an interest level selection may be received, from the computing device 106, corresponding to each of the identified at least one offer data entry 210, wherein the interest level selection represents one interest level of a plurality of interest levels indicated by the consumer 108 as a measure of interest towards the respective related offer. In one embodiment, the plurality of interest levels may include at least one of: no interest in the respective offer, interest in the respective offer with non-ideal timing, interest in the respective offer with lack of personalization, and great interest in the respective offer. In step 612, the offer feedback data in the consumer profile 214 may be updated to include at least the offer data and the received interest level selection for each of the identified at least one offer data entries 210.

### Exemplary Method for Providing Consumer Feedback to Offers

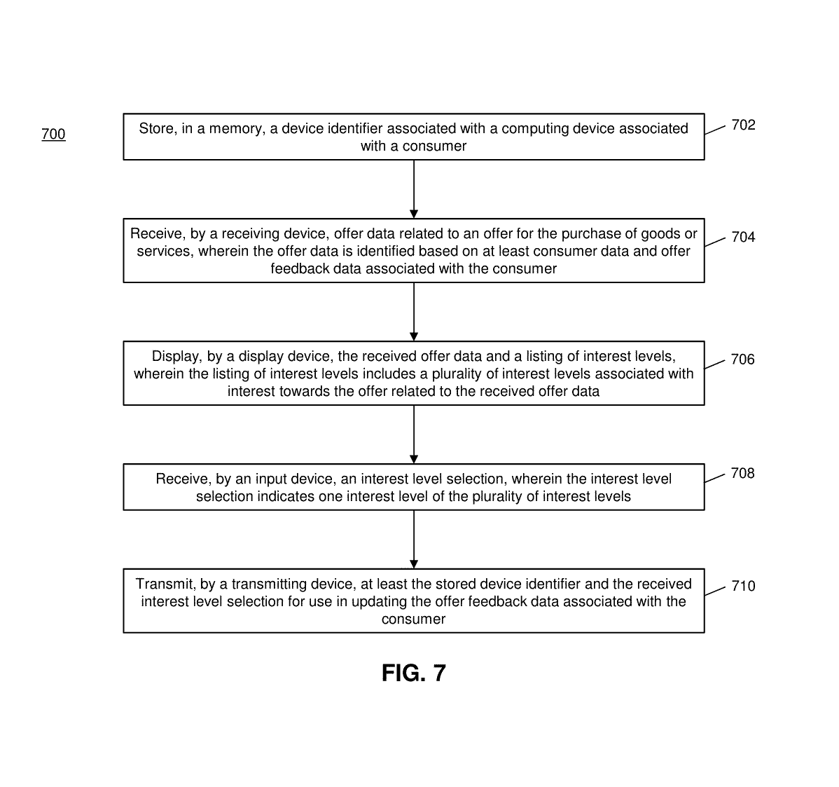

FIG. 7 illustrates a method 700 for the providing of consumer feedback to offers using multiple levels of interest.

In step 702, a device identifier (e.g., the device identifier 310) associated with a computing device (e.g., the computing device 106) associated with a consumer (e.g., the consumer 108) may be stored in a memory (e.g., the memory 308). In one embodiment, the computing device 106 may be a mobile communication device, and the device identifier 310 may be at least one of: a phone number, an Internet protocol address, a media access control address, a serial number, a registration number, and an e-mail address.

In step 704, offer data related to an offer for the purchase of goods or services may be received, by a receiving device (e.g., the receiving unit 302), wherein the offer data is identified based on at least consumer data and offer feedback data associated with the consumer 108. In one embodiment, the offer data may include at least one of: offer name, offer description, offer category, offer type, offer amount, transaction modifier, merchant data, manufacturer data, product data, start date, expiration date, quantity, and limitations on redemption. In some embodiments, the consumer data may include at least one of: demographic data, transaction data, and offer redemption data. In step 706, the received offer data and a listing of interest levels may be displayed by a display device (e.g., the display unit 314), wherein the listing of interest levels includes a plurality of interest levels associated with interest towards the offer related to the received offer data.

In step 708, an interest level selection may be received, by an input device (e.g., the input unit 316), wherein the interest level selection indicates one interest level of the plurality of interest levels. In one embodiment, the plurality of interest levels may include at least one of: no interest in the respective offer, interest in the respective offer with non-ideal timing, interest in the respective offer with lack of personalization, and great interest in the respective offer. In step 710, at least the stored device identifier 310 and the received interest level selection may be transmitted, by a transmitting device (e.g., the transmitting unit 206), for use in updating the offer feedback data associated with the consumer 108.

### Computer System Architecture

FIG. 8 illustrates a computer system 800 in which embodiments of the present disclosure, or portions thereof, may be implemented as computer-readable code. For example, the processing server 102 and the computing device 106 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4, 6, and 7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 4, 6, and 7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for distributing feedback-based offers and providing consumer feedback to distributed offers. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for distributing feedback-based offers, comprising:
storing, in an offer database, a plurality of offer data entries, wherein each offer data entry includes data related to an offer for the purchase of goods or services including at least an offer identifier, offer data, and one or more distribution conditions;
storing, in a consumer database, a consumer profile, wherein the consumer profile includes data related to a consumer including at least a device identifier, consumer data, and offer feedback data;
identifying, in the offer database, at least one offer data entry based on the included one or more distribution conditions and the consumer data and offer feedback data included in the consumer profile;
transmitting, by a transmitting device, at least the offer data included in each of the identified at least one offer data entry to a computing device associated with the device identifier included in the consumer profile;
receiving, from the computing device, an interest level selection corresponding to each of the identified at least one offer data entry, wherein the interest level selection represents one interest level of a plurality of interest levels indicated by the consumer as a measure of interest towards the respective related offer; and
updating, in the consumer profile, the offer feedback data to include at least the offer data and received interest level selection for each of the identified at least one offer data entry.

2. The method of claim 1, wherein the offer data includes at least one of: offer name, offer description, offer category, offer type, offer amount, transaction modifier, merchant data, manufacturer data, product data, start date, expiration date, quantity, and limitations on redemption.

3. The method of claim 1, wherein the consumer data includes at least one of: demographic data, transaction data, and offer redemption data.

4. The method of claim 1, wherein the plurality of interest levels include at least one of: no interest in the respective offer, interest in the respective offer with non-ideal timing, interest in the respective offer with lack of personalization, and great interest in the respective offer.

5. The method of claim 1, wherein the computing device is a mobile communication device and the device identifier is at least one of: a phone number, an internet protocol address, a media access control address, a serial number, a registration number, and an e-mail address.

6. The method of claim 1, wherein the distribution conditions includes at least one of: determined consumer interest, merchant instructions, advertiser instructions, preselected demographic characteristics of consumers, demographic segments to which consumers belong, time of day, week or year, geographic location, geographic proximity.

7. A method for providing consumer feedback to offers, comprising:
storing, in a memory, a device identifier associated with a computing device associated with a consumer;
receiving, by a receiving device, offer data related to an offer for the purchase of goods or services, wherein the offer data is identified based on at least consumer data and offer feedback data associated with the consumer;
displaying, by a display device, the received offer data and a listing of interest levels, wherein the listing of interest levels includes a plurality of interest levels associated with interest towards the offer related to the received offer data;
receiving, by an input device, an interest level selection, wherein the interest level selection indicates one interest level of the plurality of interest levels;
transmitting, by a transmitting device, at least the stored device identifier and the received interest level selection for use in updating the offer feedback data associated with the consumer.

8. The method of claim 7, wherein the offer data includes at least one of: offer name, offer description, offer category, offer type, offer amount, transaction modifier, merchant data, manufacturer data, product data, start date, expiration date, quantity, and limitations on redemption.

9. The method of claim 7, wherein the consumer data includes at least one of: demographic data, transaction data, and offer redemption data.

10. The method of claim 7, wherein the plurality of interest levels include at least one of: no interest in the respective offer, interest in the respective offer with non-ideal timing, interest in the respective offer with lack of personalization, and great interest in the respective offer.

11. The method of claim 7, wherein the computing device is a mobile communication device and the device identifier is at least one of: a phone number, an internet protocol address, a media access control address, a serial number, a registration number, and an e-mail address.

12. A system for distributing feedback-based offers, comprising:
offer database configured to store a plurality of offer data entries, wherein each offer data entry includes data related to an offer for the purchase of goods or services including at least an offer identifier, offer data, and one or more distribution conditions;
a consumer database configured to store, a consumer profile, wherein the consumer profile includes data related to a consumer including at least a device identifier, consumer data, and offer feedback data;
a processing device configured to identify, in the offer database, at least one offer data entry based on the included one or more distribution conditions and the consumer data and offer feedback data included in the consumer profile;
a transmitting device configured to transmit at least the offer data included in each of the identified at least one offer data entry to a computing device associated with the device identifier included in the consumer profile; and
a receiving device configured to receive, from the computing device, an interest level selection corresponding to each of the identified at least one offer data entry, wherein the interest level selection represents one interest level of a plurality of interest levels indicated by the consumer as a measure of interest towards the respective related offer, wherein
the processing device is further configured to update, in the consumer profile, the offer feedback data to include at least the offer data and received interest level selection for each of the identified at least one offer data entry.

13. The system of claim 12, wherein the offer data includes at least one of: offer name, offer description, offer category, offer type, offer amount, transaction modifier, merchant data, manufacturer data, product data, start date, expiration date, quantity, and limitations on redemption.

14. The system of claim 12, wherein the consumer data includes at least one of: demographic data, transaction data, and offer redemption data.

15. The system of claim 12, wherein the plurality of interest levels include at least one of: no interest in the respective offer, interest in the respective offer with non-ideal timing, interest in the respective offer with lack of personalization, and great interest in the respective offer.

16. The system of claim 12, wherein the computing device is a mobile communication device and the device identifier is at least one of: a phone number, an internet protocol address, a media access control address, a serial number, a registration number, and an e-mail address.

17. The method of claim 12, wherein the distribution conditions includes at least one of: determined consumer interest, merchant instructions, advertiser instructions, preselected demographic characteristics of consumers, demographic segments to which consumers belong, time of day, week or year, geographic location, geographic proximity.

18. A system for providing consumer feedback to offers, comprising:
a memory configured to store a device identifier associated with a computing device associated with a consumer;
a receiving device configured to receive offer data related to an offer for the purchase of goods or services, wherein the offer data is identified based on at least consumer data and offer feedback data associated with the consumer;
a display device configured to display the received offer data and a listing of interest levels, wherein the listing of interest levels includes a plurality of interest levels associated with interest towards the offer related to the received offer data;
an input device configured to receive an interest level selection, wherein the interest level selection indicates one interest level of the plurality of interest levels; and
a transmitting device configured to transmit at least the stored device identifier and the received interest level selection for use in updating the offer feedback data associated with the consumer.

19. The system of claim 18, wherein the offer data includes at least one of: offer name, offer description, offer category, offer type, offer amount, transaction modifier, merchant data, manufacturer data, product data, start date, expiration date, quantity, and limitations on redemption.

20. The system of claim 18, wherein the consumer data includes at least one of: demographic data, transaction data, and offer redemption data.

21. The system of claim 18, wherein the plurality of interest levels include at least one of: no interest in the respective offer, interest in the respective offer with non-ideal timing, interest in the respective offer with lack of personalization, and great interest in the respective offer.

22. The system of claim 18, wherein the computing device is a mobile communication device and the device identifier is at least one of: a phone number, an internet protocol address, a media access control address, a serial number, a registration number, and an e-mail address.
